(19) United States
(12) Patent Application Publication
(10) Pub. No.: US 2021/0123893 A1
(43) Pub. Date: Apr. 29, 2021

(54) CHROMATOGRAPHY SURFACE ENHANCED LUMINESCENCE (SEL) SENSING

(71) Applicant: Hewlett-Packard Development Company, L.P., Spring, TX (US)

(72) Inventors: Viktor Shkolnikov, Palo Alto, CA (US); Milo Overbay, Corvallis, OR (US)

(73) Assignee: Hewlett-Packard Development Company, L.P., Spring, TX (US)

(21) Appl. No.: 16/617,009

(22) PCT Filed: Sep. 14, 2017
(86) PCT No.: PCT/US2017/051526

§ 371 Date: Nov. 26, 2019

(51) Int. Cl. G01N 30/74; G01N 30/84; G01N 21/65; G01N 30/72; B01L 3/00

(52) U.S. Cl. CPC G01N 30/74; G01N 30/84; G01N 21/65; G01N 2030/027; B01L 3/502715; G01N 2030/8411; G01N 30/72

(57) ABSTRACT

A chromatography-surface enhanced luminescence (SEL) sensing system may include a chromatography subsystem to separate a sample into eluate fractions having different elution times, an SEL stage and an eluate fraction dispenser. The eluate fraction dispenser is to direct different eluate fractions onto distinct regions of the SEL stage based upon the different elution times.

### BACKGROUND

Chromatography is used for the separation of a sample into its various components or fractions. The components or fractions of the sample travel at different speeds, facilitating their separation. The separated components or fractions may be later used or analyzed.

### BRIEF DESCRIPTION OF THE DRAWINGS

FIG. 1 is a schematic diagram illustrating portions of an example chromatography surface enhanced luminescence (SEL) sensing system.

FIG. 2 is a diagram illustrating an example of the direction of different eluate fractions to different regions of an SEL stage over time based upon different elution times of the different eluate fractions.

FIG. 3 is a flow diagram of an example method for separating and sensing a sample.

FIG. 4 is a schematic diagram illustrating portions of an example chromatography SEL sensing system.

FIG. 5 is a flow diagram of an example method for separating and sensing a sample.

FIG. 6 is a schematic diagram illustrating portions of an example chromatography SEL sensing system at a first example point in time.

FIG. 7 is a schematic diagram illustrating portions of the example chromatography SEL sensing system of FIG. 6 at a second example point in time.

FIG. 8 is a schematic diagram illustrating portions of an example chromatography SEL sensing system.

FIG. 9 is a schematic diagram illustrating portions of an example chromatography SEL sensing system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Surface enhanced luminescence (SEL) is sometimes used for analyzing the structure of inorganic materials and complex organic molecules. SEL focuses electromagnetic radiation or light onto an analyte or solution containing an analyte, wherein the interaction between the light and the analyte is detected for analysis. One example of SEL is surface enhanced Raman spectroscopy (SERS). Because chromatography often involves the continuous or near continuous output of eluate (effluent) fractions and because many SEL techniques involve laborious activation processes, SEL techniques are difficult to use for analyzing the different eluate fractions output by chromatography.

For purposes of this disclosure, the term “eluate” is a mobile phase or effluent leaving a chromatography substrate, such as a column. The term “eluite” refers to the analyte or the eluted solute. The term “eluent” refers to a solvent or solvents that carry the analyte(s) or eluted solute.

Disclosed herein are example chromatography-SEL sensing systems and methods that facilitate the use of SEL techniques in combination with chromatography. The example systems and methods adapt to the largely uninterrupted or substantially continuous output of fractions from a chromatography process by dispensing the different fractions onto distinct regions of an SEL stage. In some implementations, the SEL stage is controllably advanced or repositioned based upon the different elution times for the different fractions from the chromatography process. In some implementations, the eluate fraction dispenser is controllably advanced or repositioned with respect to the different regions of the stage based upon the different elution times for the different fractions from the chromatography process. The different fractions may then be analyzed using SEL techniques to acquire additional information regarding the eluate fractions. Such systems and methods may facilitate continuous SEL analysis or data output.

The SEL stage may comprise a surface upon which the analyte is deposited or dispensed, wherein the surface has characteristics that enhance the interactions or optical response of the analyte when being interrogated by electromagnetic radiation or light. For example, in some implementations, the SEL stage may comprise a plasmonically active surface. Examples of plasmonic analyte interrogation applications for which an SEL stage may be employed comprise Raman spectroscopy, surface enhanced Raman spectroscopy (SERS), luminescence, surface enhanced fluorescence and others.

In one implementation, the plasmonically active surface may comprise a layer of gold. In other implementations, the plasmonically active surface may comprise other plasmonically active materials such as transition metals. In some implementations, the plasmonically active surface may comprise a plasmonically active material such as silver, copper, aluminum or other suitable conductive materials with complex dielectric properties chosen to maximize resonance at the interrogation wavelength of choice. In one implementation, the plasmonically active surface is formed upon a substrate formed from a material such as silicon, ceramics, glass and the like. In some implementations, the plasmonically active surface is formed upon a regularly patterned or irregularly patterned surface facilitating surface enhanced luminescence or surface enhanced Raman spectroscopy. For example, in one implementation, the plasmonically active surface may be formed upon a roughened surface or upon tips of pillars or nano wires. The plasmonically active surface provides enhanced plasmonic resonance upon being irradiated.

Disclosed herein is an example chromatography-surface enhanced luminescence (SEL) sensing system. The system may include a chromatography subsystem to separate samples into eluate fractions, the fractions having different elution times. The system further comprises an SEL stage and an eluate fraction dispenser to direct different eluate fractions onto distinct regions of the SEL stage, wherein at least one of the dispenser and stage are controlled to direct the different eluate fractions onto distinct regions of the SEL stage based upon the different elution times.

In some implementations, an actuator may move the dispenser relative to the stage. In other implementations, an actuator may move the stage relative to the dispenser. In some implementations, the stage may comprise a disk having distinct circumferential regions, wherein the actuator rotates the distinct circumferential regions to receive different eluate fractions based upon the different elution times of the different eluate fractions. In other implementations, the stage may comprise a strip having distinct serial or linearly ordered regions, wherein the actuator comprises a linear actuator that translates the distinct linearly ordered regions to receive the different eluate fractions based upon the different elution times of the different eluate fractions.

In some implementations, the actuator may further move the stage to position the distinct regions of the stage that have received the eluate fractions for sensing. For example, the actuator may move the stage to position the regions of the stage with the received eluate fractions before a source of electromagnetic radiation or light and before a sensor that senses the response of the eluate fractions to the interrogating light. In some implementations, a sample driver or pump may supply the sample to the chromatography subsystem.

In some implementations, parallel sensing of the eluate fractions output from the chromatography subsystem is carried out. For example, an eluate splitter may split and direct an eluate fraction into two portions, a first portion to be dispensed onto the SEL stage for SEL sensing and a second portion to be sensed with a parallel sensing technique such as mass spectroscopy. In some implementations, where the solvent used during chromatography is not well-suited for the SEL process, the system may further include a solvent exchanger following chromatography to provide the fraction with a more SEL friendly solvent for SEL sensing. In some implementations where the SEL stage comprises nano pillars, the dispenser may comprise a nebulizer to disperse the eluate fraction onto the nano pillars.

Disclosed herein is an example method that facilitates the use of SEL sensing following chromatography. The example method may include separating a sample into eluate fractions using chromatography and then directing the different eluate fractions onto distinct regions of a surface enhanced luminescence (SEL) stage based upon different elution times of the different eluate fractions. The method may involve sequentially positioning the distinct regions of the SEL stage with the respective different eluate fractions opposite an SEL sensor and sensing each of the different eluate fractions with the SEL sensor.

Disclosed herein is an example non-transitory computer-readable medium that contains instructions for directing a processor to facilitate SEL sensing following chromatography. The instructions may direct the processor to receive signals indicating movement of a sample through a chromatography subsystem, to determine different elution times for the different eluate fractions from the chromatography subsystem and output control signals to an actuator. Based upon the control signals, the actuator may move one of the dispenser and a surface enhanced luminescence (SEL) stage relative to another based upon the different elution times for the different eluate fractions to direct the different eluate fractions to distinct regions of the SEL stage. The instructions may further direct the processor to output control signals to the same actuator or a different actuator to move the distinct regions of the SEL stage opposite to an SEL sensor.

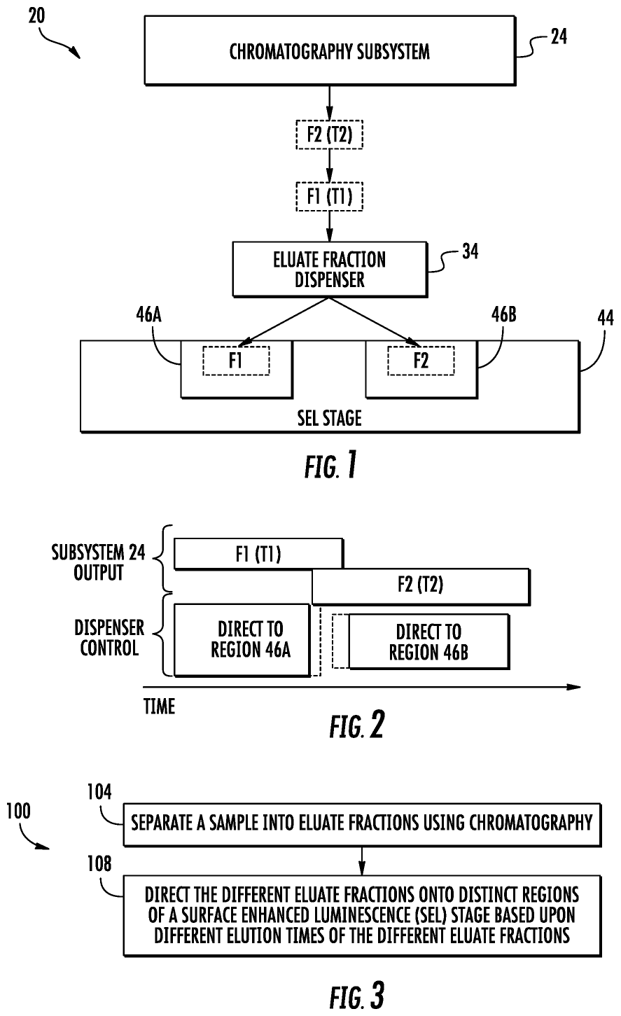

FIG. 1 is a schematic diagram illustrating portions of an example chromatography-surface enhanced luminescence (SEL) sensing system 20. System 20 facilitates the use of SEL techniques in combination with chromatography. System 20 accommodates the largely uninterrupted or continuous output of fractions from a chromatography process by dispensing the different fractions onto distinct regions of an SEL stage based upon the different elution times for the different fractions from the chromatography process. System 20 comprises chromatography subsystem 24, eluate fraction dispenser 34 and SEL stage 44.

Chromatography subsystem 24 comprises a system that is to separate components of a mixture sample or analyte into its various components or eluate fractions. In some implementations, chromatography subsystem 24 comprises a chromatography substrate which interacts with the sample formed by a matrix, analytes and at least one solvent. The chromatography substrate, whether in columns/tubes or in a planar geometry, differently interacts with each of the different analytes and/or matrix such that the different analytes/matrix in the sample pass through or across the chromatography substrate at different rates, separate and exit the substrate, as eluate fractions, during different windows of time referred to as elution times or elution time windows.

As schematically shown by broken lines, chromatography subsystem 24 outputs different eluate fractions F1 and F2 at different times, time T1 and time T2, respectively. In some implementations, the windows of time during which the different fractions F1 and F2 are discharged from subsystem 24 are spaced in time from one another, such as with affinity chromatography. In other implementations or with other forms a chromatography, the windows of time during which the different fractions F1 and F2 are discharged from subsystem 24 abut one another in time or partially overlap one another in time. For example, in some implementations, the different fractions F1 and F2 may be discharged according to a Gaussian curve, wherein in portions of the Gaussian curve overlap such that during the overlapping periods of time, the output of subsystem 24 may be a mixture of the two fractions.

Eluate fraction dispenser 34 comprise a device that receives the eluate fractions and selectively deposits, dispenses or directs the different eluate fractions onto different regions 46A, 46B (collectively referred to as regions 46) of SEL stage 44. Eluate fraction dispenser 34 is fluidly coupled to chromatography subsystem 24 to receive the output of subsystem 24. In one implementation, eluate fraction dispenser 34 comprises a nebulizer fluidly coupled to chromatography subsystem 24. In other implementations, eluate fraction dispenser 34 may comprise other dispensing devices that are fluidly coupled to chromatography subsystem 24.

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members. The term “fluidly coupled” shall mean that two or more fluid transmitting volumes are connected directly to one another or are connected to one another by intermediate volumes or spaces such that fluid may flow from one volume into the other volume.

Eluate fraction dispenser 34 dispenses the different eluate fractions based upon the different elution times. For example, during time T1 (the time window at which fraction F1 is discharged), dispenser 34 may deposit eluate fraction F1 onto a first region 46 of stage 44. During time T2, (the time window at which fraction F2 is discharged), dispenser 34 may deposit eluate fraction F2 onto a second distinct region 46B of stage 44.

FIG. 2 is a diagram illustrating a circumstance where eluate fractions F1 and F2 have overlapping discharge windows T1 and T2. In one implementation, eluate fraction dispenser 34 directs the output of subsystem 24 during the nonoverlapping portion of window T1 to region 46A and directs the output of subsystem 24 during the nonoverlapping portion of window T2 to region 46B so as to avoid or reduce the extent to which the different effluent fractions or different analytes are mixed in the different regions 46 of SEL stage 44. In some implementations, where a slight mixing of different fractions or different analytes is tolerable, dispenser 34 may direct a share of the overlapping portion of window T1 to region 46A and/or a share of the overlapping portion of window T2 to region 46B. For example, where the concentration or rate of discharge of fractions F1 and F2 follows a Gaussian curve or distribution, such overlapping shares may constitute a relatively small and acceptable amount or percentage of the non-targeted or minority analyte. The extent to which the fractions during the overlapping portions are directed to stage 44 may vary depending upon a desired level of purity of the targeted analyte or fraction for the deposit in each of the distinct regions 46.

Those portions of the output from subsystem 24 which are not directed to stage 44 may be discharged as waste. In some implementations, dispenser 34 may direct different portions of the output of subsystem 24 to different regions 46 of stage 44 based upon a level of purity of the output of subsystem 24. For example, dispenser 34 may direct the output of subsystem 24 having a higher level of purity respect to a particular fraction to a first group of selected regions 46 of substrate 44 and may direct the output of subsystem 24 having a lower level of purity (such as the output of 24 during an overlap of time windows T1 and T2) to a second group of selected regions 46 of substrate 44. In such an implementation, each of the regions may undergo SEL interrogation and analysis, but wherein different levels of confidence or different weightings may be assigned to the results of the different regions depending upon the level of purity of the deposit on each of the regions. In some implementations, depending upon the level of purity of the deposit in each of the regions, the different regions may undergo different SEL interrogation processes or may undergo SEL interrogation for different lengths of time.

SEL stage 44 comprises a plurality of distinct regions 46 onto which different eluate fractions output from subsystem 24 may be directed or deposited. In one implementation, regions 46 are physically spaced, separated or isolated from one another by gaps or by intervening valleys or walls. In another implementation, regions 46 may not be physically separated from one another by intervening walls or boundaries, but constitute different areas on substrate 44. In one implementation, regions 46 comprise different groups or sets of nano fingers or nano pillars. For example, in one implementation, such nano pillars comprise posts having tips formed from a plasmonically active material to form a plasmonically active surface. In one implementation, stage 44 comprises an array of nano pillar clusters or groupings, each grouping comprising five closely associated nano pillars that are to collapse towards one another when activated. In such an implementation, each region 46 comprises a subset of the total number of nano pillar groupings. In other implementations, stage 44 may comprise other plasmonically active surfaces, wherein distinct areas of the total surface form the different regions 46.

In one implementation, the selective dispensing or directing of the different eluate fractions to the different regions 46 is facilitated by the controlled repositioning of dispenser 34 relative to stage 44. In another implementation, the selective dispensing or directing of the different eluate fractions to the different regions 46 is facilitated by the controlled repositioning of stage 44 relative to dispenser 34. In some implementations, the selective dispensing or directing of the different eluate fractions to the different regions 46 is facilitated by the controlled repositioning of both stage 44 and dispenser 34 relative to one another.

FIG. 3 is a flow diagram of an example method 100 for analyzing a sample. For purposes of this disclosure, method 100 is described as being carried out by system 20. It should be appreciated that method 100 may be carried out with any of the systems described in the disclosure or other similar such systems.

As indicated by block 104, chromatography subsystem 24 separates a sample into different eluate fractions. In one implementation, the sample may comprise multiple analytes, a matrix and a solvent. The different analytes interact differently with a chromatography substrate such that the different analytes exit from the chromatography substrate at different times or during different time windows.

As indicated by block 108, the different eluate fractions are directed onto distinct regions of a surface enhanced luminescence stage. With system 20, the different eluate fractions are directed to distinct regions 46 of SEL stage 44 by eluate fraction dispenser 34. Eluate fraction dispenser 34 directs such eluate fractions to the different regions based upon the different elution times of the different eluate fractions. For example, during the time window during which the first eluate fraction F1 is expected or anticipated to be discharged from subsystem 24, system 20 may be in a first state such that dispenser 34 directs all of the output from subsystem 24 to a first region 46A of an SEL stage 44. Upon expiration of the time window, system 20 may change to a second state such that dispenser 34 directs all of the output from subsystem 24 to a second region 46B of SEL stage 44. In one implementation, the positioning or state of dispenser 34 may change so as to differently direct the output of subsystem 24 to different regions during the two example time windows. In another implementation, the positioning or state of SEL stage 44 may change such that different regions 46 of SEL stage 44 receive the output from subsystem 24 as directed by dispenser 34. Because system 20 automatically changes to selectively direct the output of chromatography subsystem 24 to different regions of SEL stage 44 based upon the different expected elution times, method 100 and system 20 accommodate the stream or streams of output during chromatography.

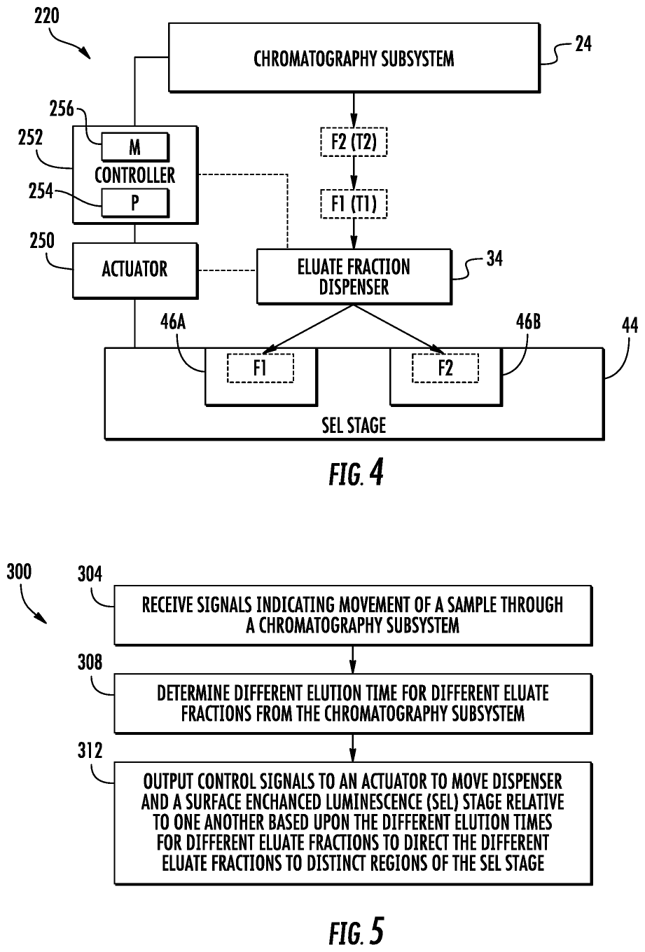

FIG. 4 schematically illustrates portions of an example chromatography-surface enhanced luminescence (SEL) sensing system 220. As with system 20, system 220 facilitates the use of SEL techniques in combination with chromatography. System 220 accommodates the largely uninterrupted or continuous output of fractions from a chromatography process by dispensing the different fractions onto distinct regions of an SEL stage based upon the different elution times for the different fractions from the chromatography process. System 220 is similar to system 20 except that system 220 is disclosed as explicitly additionally comprising actuator 250 and controller 252. Those remaining components of system 220 which correspond to components of system 20 are numbered similarly.

Actuator 250 comprises an electronically controlled and powered mechanism operably coupled to either or both of dispenser 34 and stage 44 to move dispenser 34 and stage 44 relative to one another. In the example illustrated, actuator 250 is operably coupled to SEL stage 44 to reposition stage 44 relative to dispenser 34 such that dispenser 34 deposits or directs different eluate fractions to different regions 46 at different times. As indicated by broken lines, in other implementations, actuator 250 may be operably coupled to dispenser 34 to reposition dispenser 34 relative to stage 44 such that the different regions of stage 44 receive different eluate fractions at different times. In one implementation, actuator 250 may be operably coupled to both dispenser 34 and 44, wherein dispenser 34 and stage 44 moved together in unison as a particular region is being filled with an eluate fraction and move relative to one another when a new region 46 of stage 44 is to receive a different eluate fraction.

In one implementation, SEL stage 44 may comprise a rotatable disk having different angularly spaced regions or pie-shaped regions that are to receive different eluate fractions based on the different elution times of the different eluate fractions. In such an implementation, actuator 250 comprises a rotary actuator which rotates the disk. In one implementation, such rotation is continuous. In another implementation, such rotation is stepwise or intermittent. In one implementation, the angular rotation of the disk is at a constant rate. In another implementation, the angular rotation of the disk is at a varying rate under the control of controller 252. Examples of such a rotary actuator include, but are not limited to a servo motor, stepper motor or the like.

In one implementation, SEL stage 44 may comprise an elongate strip having distinct linearly ordered regions 46 that are to receive different eluate fractions. In such an implementation, actuator 250 may comprise a linear actuator which linearly translates the distinct linearly ordered regions relative to dispenser 34 such that the different regions 46 receive the different eluate fractions based upon the different elution times of the different eluate fractions. In one implementation, such linear translation is continuous. In another implementation, such linear translation is stepwise or intermittent. In one implementation, the linear translation of the strip is at a constant rate. In another implementation, the linear translation of the strip is at a varying rate under the control of controller 252. Examples of such a linear actuator include, but are not limited to, a pneumatic cylinder-piston assembly, an electric solenoid and a conveyor.

Controller 252 comprises electronics that control at least actuator 250. In the example illustrated, controller 252 comprises processor 254 and memory 256. Processor 254 comprises a processing unit that carries out instructions stored and provided from memory 256. Memory 256 comprises a non-transitory computer-readable medium containing such code or instructions. In other implementations, controller 252 may comprise an integrated circuit that controls actuator 250.

Processor 254, following instructions stored in memory 256, outputs control signals that direct the operation of actuator 250. In some implementations, eluate fraction dispenser 34 automatically dispenses material in a continuous fashion or periodically. In some implementations, eluate fraction dispenser 34 may dispense material at controlled times. In such an implementation, processor 254 of controller 252 may additionally output control signals that control the dispensing of eluate fractions by dispenser 34. Controller 252 generates such control signals controlling actuator 250 (and dispenser 34 in some implementations) based upon the anticipated, expected or determined different elution times for different eluate fractions being output by chromatography subsystem 24.

In one implementation, memory 256 may store previously determined times (windows of time) for the output of different eluate fractions from chromatography subsystem 24. For example, memory 256 may store a lookup table which identifies the different elution times for different elution fractions in different sample mixtures. In some implementations, memory 256 may direct a processor 254 to retrieve such different elution times from external sources. In such implementations, controller 252 may receive signals or input for a person indicating or identifying sufficient characteristics of the sample to identify the different elution times. In other implementations, controller 252 may receive input from a person directly indicating the different elution times for the different eluate fractions.

In such implementations, controller 252 may be additionally coupled to chromatography subsystem 24 to synchronize with subsystem 24, to identify a clocking or timing for each of the different elution times. In one implementation, the different elution times may be based upon the time at which a sample deposited into chromatography subsystem 24. In other implementations, the different elution-based upon when a sample has passed a certain point within chromatography subsystem 24. In one implementation, the depositing the sample into subsystem 24 or the passing of the sample past a certain checkpoint within subsystem 24 may be sensed by a sensor associated with subsystem 24. In another implementation, the depositing of the sample into subsystem 24 or the passing of the sample past a certain checkpoint within subsystem 24 may be identified to controller 252 by an operator with an input device.

Once an eluate fraction has been deposited by dispenser 34 in a distinct region 46 of SEL stage 44, the SEL stage 44 may be “activated” to ready the eluate fraction on the distinct region 46 of stage 44 for SEL interrogation. Such “activation” may be carried out in multiple manners depending upon the particular characteristics of the sample being interrogated as well as the particular characteristics of the SEL technique and stage 44 being utilized. In one implementation in which SEL stage 44 comprises a flexible nano pillars (as described above), such “activation” is achieved by causing the nano pillars or selected groups/clusters of nano pillars to collapse or close towards one another so as to create plasmonically “hotspots”. In some implementations, the closing or collapse of the nano pillars towards one another is achieved by allowing the solvent of the eluate fraction to evaporate such that the nano pillars close towards one another through capillary forces. In some implementations, the closing or collapse of the nano pillars towards one another is further facilitated by the controlled and selective application of heat to the distinct region to accelerate such evaporation.

Once the particular region 46 of stage 44, supporting the deposit eluate fraction, has been “activated”, the particular region 46 may be positioned opposite to an SEL light source and sensor for interrogation. In one implementation, the entire stage 44 may be carried and repositioned opposite to such a light source and sensor. In another implementation, those portions of stage 44 that have been activated and that are ready for interrogation may be severed or separated from those portions stage 44 that await either the receipt of an eluate fraction or such “activation”, wherein the severed or separated portion of stage 44 is conveyed or otherwise transported to a position opposite to the SEL interrogation light source and sensor.

In yet another implementation, system 220 may comprise multiple stations for carrying out (a) the dispensing of different eluate fractions onto distinct regions of stage 44, (b) the activation of the particular region with the deposited eluate fraction and (c) the SEL interrogation of eluate fraction on the the activated region 46 of stage 44. In such an implementation, actuator 250 may additionally position the different regions 46 at each of such stations. For example, in implementations where stage 44 comprises a rotatable disk, such stations may be angularly positioned about the rotational axis of the disk, wherein actuator 250 rotates the distinct regions 46 between the different stations. In implementation for stage 44 comprises a strip, such stations may be serially positioned relative to one another, wherein actuator 250 translate the distinct regions 46 between the different stations. In some implementations, system 220 may comprise an additional station that cleans a region 46 after such SEL interrogation to allow a region 46 of stage 44 to be reused.

FIG. 5 is a flow diagram of an example method 300 for analyzing a sample. For purposes of this disclosure, method 300 is described as being carried out by system 220. It should be appreciated that method 300 may be carried out with any of the systems described in the disclosure or other similar systems.

As indicated by block 304, controller 252 receives signals indicating movement of a sample through chromatography subsystem 24. Such signals may indicate the input of the sample into chromatography subsystem 24 or the passing of the sample portions of the sample past certain checkpoints within subsystem 24. Such signals may originate from a sensor or may have been generated in response to input from a person using system 220. Such signals are used to identify when, in real time, a particular elution time for a particular eluate fraction occurs.

As indicated by block 308, controller 252 determines the different elution times for the different eluate fractions being output from the chromatography subsystem 24. The different elution times are based in part upon the signals received in block 304 indicating the time at which a clock or timer should be started and a received elution time (the point in time following the start of the clock that an eluate fraction being output or discharged from subsystem 24 to fraction dispenser 34) for each of the different eluate fractions to be output by subsystem 24 for the sample being tested. In one implementation, controller 252 may retrieve the different elution times from memory 256 or an external memory source. In another implementation, controller 252 may prompt a person to enter the different elution times.

As indicated by block 312, controller 252 outputs control signals to actuator 250 to move dispenser 34 and SEL stage 44 relative to one another based upon the different elution times for the different eluate fractions such that the different eluate fractions are directed to distinct regions 46 of SEL stage 44. In one implementation, such relative movement of dispenser 34 and SEL stage 44 is additionally based upon a sensed rate at which the eluate fraction is being output or the expected or predetermined rate in which the eluate fraction is to be output from chromatography subsystem 24 during a particular elution time/time window. For example, during elution time T1, the eluate fraction F1 may be output from subsystem 24 at a varying rate or with varying relative concentrations of the analyte with respect to the solvent(s) and/or matrix. In such an implementation, the rate at which dispenser 34 and stage 44 are moved relative to one another may also vary or occur at a non-uniform rate to accommodate the varying rate at which an eluate fraction is output from subsystem 24 or the varying relative concentrations during a particular elution time/time window. For example, during those portions of a particular elution time having a higher rate at which the eluate fraction is discharged from subsystem 24 or during those portions of a particular elution time/time window having a higher concentration of the analyte to be tested as compared to the concentration of the solvent(s) and/or matrix, controller 252 may control actuator 250 to move dispenser 34 and stage 44 relative to one another (by moving one or both relative to the other) at a higher speed or rate. As a result, a more uniform deposition of the eluate fraction and/or the particular analyte(s) of the eluate fraction across the particular region 46 may be achieved.

In other implementations, dispenser 34 and stage 44 may be positioned relative to one another such that dispenser 34 deposits the eluate fraction towards a central or center portion of the particular region 46 during those portions of the particular elution time having a higher rate or analyte concentration. During those portions of the particular elution time having a lower flow rate or a lower analyte concentration, dispenser 34 and stage 44 may be positioned relative to one another such that the eluate fraction is deposited along the perimeter of the particular region 46. Such control may assist in maintaining the boundaries between the different regions 46 and/or may facilitate deposition of the analyte(s) in the central region of the region for subsequent SEL interrogation.

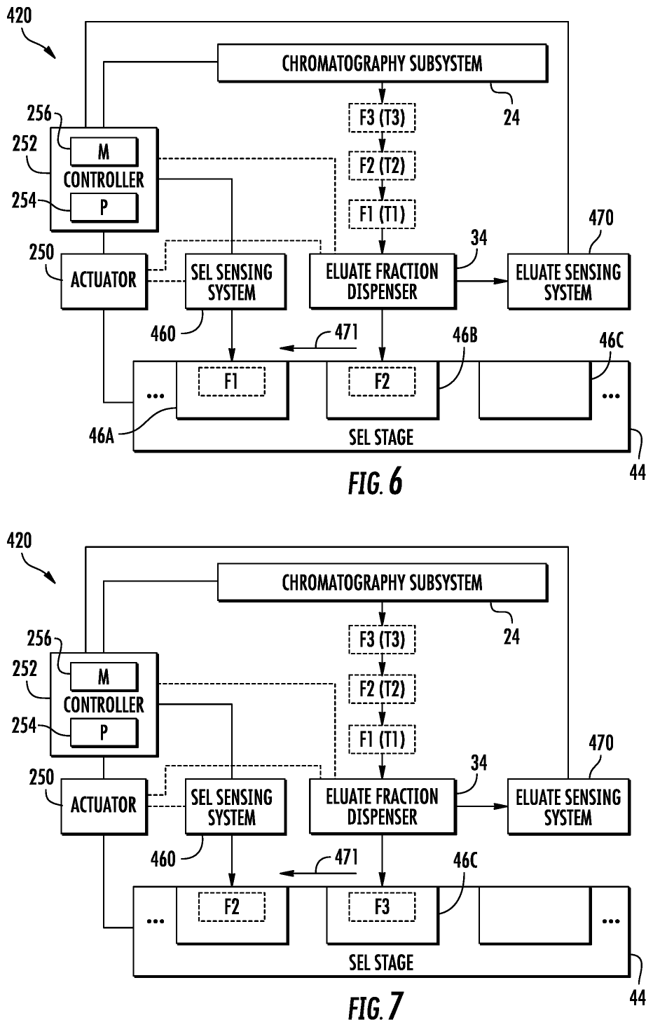

FIG. 6 schematically illustrates portions of another example chromatography-surface enhanced luminescence (SEL) sensing system 420. As with system 20, system 420 facilitates the use of SEL techniques in combination with chromatography. System 420 accommodates the largely uninterrupted or continuous output of fractions from a chromatography process by dispensing the different fractions onto distinct regions of an SEL stage based upon the different elution times for the different fractions from the chromatography process. System 420 is similar to system 220 except that system 420 is disclosed as explicitly additionally comprising SEL sensing system 460 and eluate sensing system 470. Those remaining components of system 420 which correspond to components of system 220 are numbered similarly.

SEL sensing system 460 interrogates or senses characteristics of the eluate fraction deposited or dispensed into each of regions 46 of SEL stage 44. SEL sensing system 460 comprises a light emitter and an optical sensor. The light emitter directs or focuses an interrogating light at the eluate fraction in the particular region of stage 44. The optical sensor senses light originating from the eluate fraction in the particular region 46 in response to the interrogating light. In one implementation, the light originating from eluate fraction may comprise a reflection of the interrogating light after modification of the interrogating light by the eluate fraction. For example, the interrogating light may undergo a wavelength shift upon interacting with the eluate fraction in the particular region 46. In one implementation, the light originating from eluate fraction may comprise fluorescence or other light emitted by the eluate fraction. The exact interaction and sensing may vary depending on the particular SEL process being utilized.

In those implementations where SEL stage 44 comprises flexible nano pillars which are to be activated by closure of the nano pillars towards one another, SEL sensing system 460 may additionally comprise a heater to facilitate evaporation of the solvent portion of the eluate fraction. Such evaporation may lead to closure collapse of the nano pillars through capillary forces. In one implementation, SEL sensing system 460 may comprise two separate stations along stage 44, a first station for applying heat and closing the nano pillars in a second station for impinging the region 46 with an interrogating light and sensing a response of the eluate fraction to the interrogating light.

Eluite sensing system 470 comprises a system that senses the eluite or analyte output by chromatography subsystem 24 in parallel with the sensing of the eluate fractions by SEL sensing system 460. In one implementation, eluite sensing system 470 may comprise a mass spectrometer. In another implementation, eluate sensing system 470 may comprise other forms of eluite sensing systems. Eluate sensing system 470 may communicate with controller 252, transmitting information or results to controller 2524 comparison are linking to the results received from system 460. Eluite sensing system facilitates the building of a detailed SEL reference library, linking or cross-referencing characteristics identified by system 470 to or with the characteristics identified by system 460.

FIGS. 6 and 7 illustrate operation of system 420, illustrating system 420 at distinct point in time. As schematically shown by FIGS. 6 and 7, chromatography subsystem 24 outputs a continuous stream or intermittent stream of effluent or eluate fractions F1, F2 and F3 at times T1, T2 and T3, respectively. FIG. 6 illustrates system 420 at a first point in time after dispenser 34 has deposited eluate fraction F1 in region 46 and after actuator 250 has repositioned stage 44 relative to dispenser 34 in the direction indicated by arrow 471. FIG. 6 illustrates system 420 at a point in time within elution time window T2 (also referred to as an elution time) during which dispenser 34 is dispensing eluate fraction F2 into region 46B of SEL stage 44.

During elution time T2, the eluate fraction dispenser 34 further serves as a fraction divider or splitter by separating a portion of the eluate fraction F2 and directing the separated portion of fraction F2 to system 470 for parallel sensing and analysis. In other implementations, a separate divider or splitter may be provided between the output of chromatography subsystem 24 and an input of dispenser 34. In yet another implementation, chromatography subsystem 24 may have two separate outputs, a first output fluidly connected dispenser 34 and a second fluid output connected to sensing system 470. In the example illustrated, while dispenser 34 is dispensing eluate fraction F2 into region 46B, controller 252 may be directing SEL sensing system 460 to interrogate and sense eluate fraction F1 in region 46A. During the same time, controller 252 may be further directing system 470 to carry out the parallel sensing of eluate fraction F1 which was previously received or may be directing system 470 to carry out parallel sensing of the eluate fraction F2 currently being received.

FIG. 7 illustrates system 420 at a second point in time, point time during elution time window T3. FIG. 7 illustrates system 420 after controller 252 has output control signals directing actuator 2502 further reposition stage 44 relative to dispenser 34 in the direction indicated by arrow 471. Such movement results in region 46B being advanced to a position opposite to SEL sensing system 460 and results in region 46C being advanced to a position opposite to dispenser 34. FIG. 7 illustrates system 420 at a point in time within elution time window T3 (also referred to as an elution time) during which dispenser 34 is dispensing eluate fraction F3 into region 46C of SEL stage 44.

During elution time T3, the eluate fraction dispenser 34 further serves as a fraction divider or splitter by separating a portion of the eluate fraction F3 and directing the separated portion of fraction F3 to system 470 for parallel sensing and analysis. In the example illustrated, while dispenser 34 is dispensing eluate fraction F3 into region 46B, controller 252 may be directing SEL sensing system 460 to interrogate and sense eluate fraction F2 in region 46B. During the same time, controller 252 may be further directing system 470 to carry out the parallel sensing of eluate fraction F2 which was previously received or may be directing system 470 to carry out parallel sensing of the eluate fraction F3 currently being received.

FIG. 8 schematically illustrates portions of another example chromatography-surface enhanced luminescence (SEL) sensing system 520. As with systems 20, 220 and 420, system 520 facilitates the use of SEL techniques in combination with chromatography. System 520 accommodates the largely uninterrupted or continuous output of fractions from a chromatography process by dispensing the different fractions onto distinct regions of an SEL stage based upon the different elution times for the different fractions from the chromatography process. System 520 comprises chromatography subsystem 524, fraction splitter 526, eluate fraction dispenser 534, SEL stage 544, actuator 550, controller 552, SEL sensing system 560 and eluite sensing system 570.

Chromatography subsystem 524 is similar to chromatography subsystem 24 in that subsystem 524 comprises a system that is to separate components of a mixture sample or analyte into its various components or eluate fractions. In each of the above-described implementations, chromatography subsystem 24 may be replaced with chromatography subsystem 524. In the example illustrated, chromatography subsystem 524 comprises solvent inputs 574A, 574B (collectively referred to as solvent inputs 574), sample input 576, pump 578 and chromatography substrate 580.

Solvent inputs 574 comprise a source reservoir containing, or input ports for receiving, solvents or eluents for use with sample 576 to carry the sample including the analyte(s). Although system 520 is illustrated as comprising two different solvent inputs 574A and 574B, system 520 may comprise a single solvent input or more than two solvent inputs. In some implementations where the solvent is already mixed with sample or where a solvent is not utilized, such solvent inputs 574 may be omitted. Sample input 576 comprises a source reservoir for containing a sample or input ports for receiving a sample, the sample comprising an analyte or multiple analytes for being separated from each other or from a surrounding matrix for subsequent sensing by SEL sensor 560 and eluite sensor 570.

Pump 578 comprise a device that moves and supplies the mixture of the sample and solvents (if applicable) to chromatography substrate 580. In one implementation, pump 578 may be under the control of controller 552. In one implementation, pump 570 may comprise an inertial pump. In other implementations, pump 570 may be provided by other pumping devices. In yet other implementations, pump 570 may be omitted, wherein the sample and the solvents (if applicable) are deposited into or onto the chromatography substrate 580 in other fashions.

Chromatography subsystem 524 comprises a chromatography substrate which interacts with the mixture of the sample (comprising analyte(s) and a surrounding matrix) and a solvent (where applicable). The chromatography substrate, whether in columns/tubes or in a planar geometry, differently interacts with each of the different analytes such that the different analytes in the sample pass through or across the chromatography substrate 580 at different rates, separate and exit the substrate, as eluate fractions or effluent, during different elution times.

Fraction splitter 526 comprises a component of system 520 that splits the output of subsystem 524 into two separate portions. Fraction but are 526 splits an eluate fraction being discharged from substrate 580 into two separate portions: a first portion which is directed to dispenser 534 and a second portion was directed to eluite sensing system 570. In implementations where eluite sensing system 570 is omitted, splitter 526 may be omitted.

Eluate fraction dispenser 534 is similar to dispenser 34 described above except that dispenser 534 is specifically illustrated as a nebulizer. As a nebulizer, dispenser 534 breaks up the eluate fraction solution into small aerosol droplets that are directed onto distinct regions of SEL stage 544. As a nebulizer, dispenser 534 facilitates more precise control over the deposition of smaller quantities of eluate fractions onto distinct regions of stage 544. In other implementations, dispenser 534 may have other forms for dispensing or depositing eluate fractions.

SEL sensing stage 544 receives different eluate fractions from dispenser 534. Sensing stage 544 is similar to sensing stage 44 except that stage 544 is specifically illustrated as a circular disk to be rotated by actuator 550 in the direction indicated by arrow 545. In one implementation, stage 544 comprises nano pillars 546, each of the nano pillars 546 comprising a flexible post supporting material at its tip that provides a plasmonically active surface for SEL sensing. As described above, in some implementations, the posts are sufficiently flexible such that the nano pillars may close or bend, bringing the tips into close proximity with one another. As described above, the tips of the plasmonically active material may comprise a material such as gold, silver or the like. As described above with respect to stage 44, in one implementation, the pillars may be provided as groups or clusters, wherein each of the nano pillars of the cluster close towards one another. In one implementation, the nano pillars may be arranged as pentamers, a grouping of five nano pillars. In other implementations, such nano pillars may have other groupings. In other implementations, stage 544 may provide other plasmonically active surfaces.

In the example illustrated, stage 544 comprises a continuous expanse of such nano pillars, wherein the distinct regions are not physically defined or separated from one another by intervening structures. In other implementations, stage 544 may comprise intervening walls or barrier separating the distinct regions 46 (schematically shown in FIG. 1). In yet other implementations, stage 544 may comprise a strip having the plasmonically activated surface, but wherein actuator 550 is linearly translates, rather than rotates the stage 544.

Actuator 550 moves stage 544 relative to dispenser 534. In the example illustrated, actuator 550 comprises a rotary motor that rotates stage 544. As described above, in implementations where stage 544 comprises a strip having a serial arrangement of regions, actuator 550 may comprise a linear actuator. Actuator 550 displaces stage 544 relative to dispenser 534 in response to control signals from controller 552, wherein the timing or rate of such displacement is based upon the elution times of the eluate fractions from chromatography subsystem 524.

Controller 552 is similar to controller 252 described above. Similar to controller 252, controller 552 may carry out method 100 and/or method 300 described above. As part of such methods, controller 552 may output control signals, based upon the different elution times of the different eluate fractions, wherein the control signals to control actuator 5502 move stage 544 relative to dispenser 534 such that the different eluate fractions are deposited upon different distinct regions of stage 544 for subsequent sensing or interrogation by sensing system 560. In the example illustrated, controller 552 additionally controls pump 578 to control the supply of the sample and associated solvent(s) to chromatography substrate 580. In some implementations, controller 552 may additionally receive the data from sensing system 570. In some implementations, controller 552 may additionally generate or output a library linking or associating the data or results from system 560 and 570.

SEL sensing system 560 is similar to SEL sensing system 460 described above except that SEL sensing system 560 is physically disclose as a Raman spectrometer. As such, system 460 interrogates the analyte deposited upon the plasmonically active surface of stage 544 with light from a light source 582 and senses the response of the analyte left in which was part of the eluate fraction) to the interrogating light with an optical sensor 584. In other implementations, SEL sensing system 560 may comprise other forms of SEL sensing systems.

Eluite sensing system 570 is similar to eluite sensing system 470 described above except that system 570 is specifically illustrated in the form of a mass spectrometer that is fluidly coupled to splitter 526 to receive a portion of the eluate fraction for sensing and analysis parallel to such sensing in analysis carried out by SEL sensing system 560. In other implementations, sensor system 570 may comprise other forms of sensing system such as UV/VIS/IR absorption spectroscopy sensors, electrochemical sensor such as amperometeric sensors, or more specific electrochemical sensors.

System 520 may operate in a fashion similar to that described above with respect to system 420. Controller 55 to output control signals causing pump 578 to supply chromatography substrate 580 with a solution comprising a sample comprising a solvent or multiple solvents that carry analyte(s) and a surrounding matrix. Different portions of the solution differently interact with the chromatography substrate 580 such that chromatography subsystem 524 outputs a continuous stream or intermittent stream of effluent or eluate fractions at different elution times.

Splitter 526 divides the different fractions into two portions or shares, a first share being directed to system 570 and a second share being directed to dispenser 534. Dispenser 534 dispenses or deposits its share of a first eluate fraction on a first region of stage 544. Based upon the determined or retrieved elution times, controller 552 outputs control signals causing actuator 550 to rotate (or otherwise move) stage 544 to position a second region, different than the first region, opposite to dispenser 534 such that the second eluate fraction discharged by chromatography subsystem 524 is deposited upon a new second region of stage 544. Such rotation of stage 544 additionally results in the first region of stage 544, with the deposited first eluate fraction being advanced to a position for interrogation by SEL sensing system 560. This cycling may continue until each of the distinct angular spaced regions of stage 544 have received a different eluate fraction that has been sensed by system 560. In one implementation, stage 554 is removably mounted to system 520, wherein at such time after use, stage 554 is removed from system 520 and a new “clean” stage 544 is inserted for use. In other implementations, system 520 may comprise a station for cleaning each of the different regions after use, readying each region for reuse.

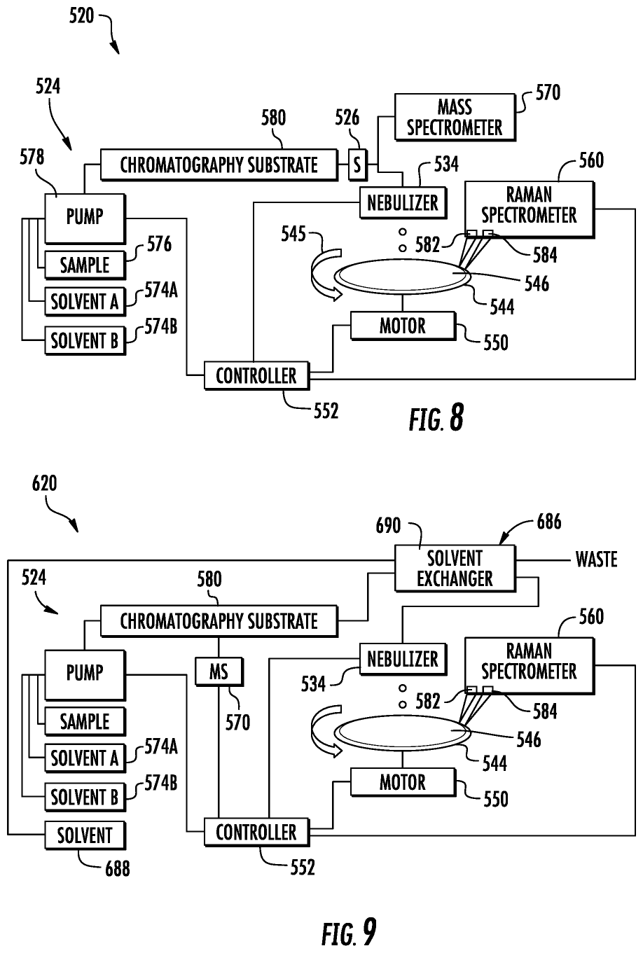

FIG. 9 schematically illustrates portions of another example chromatography-surface enhanced luminescence (SEL) sensing system 620. As with systems 20, 220, 420 and 520, system 620 facilitates the use of SEL techniques in combination with chromatography. System 620 accommodates the largely uninterrupted or continuous output of fractions from a chromatography process by dispensing the different fractions onto distinct regions of an SEL stage based upon the different elution times for the different fractions from the chromatography process. System 620 is similar to system 520 described above except that system 620 additionally comprises solvent exchange system 686. For ease of illustration, splitter 526 (shown in FIG. 8) is omitted. It should be understood that splitter 526 is located between chromatography substrate 580 and the inputs to solvent exchange system 686 and eluite sensing system 570. Those remaining components of system 620 which correspond to components of system 520 are numbered similarly.

Solvent exchange system 686 facilitates the use of solvents as part of the chromatography performed by chromatography substrate 580 that may not be friendly to the SEL sensing stage 544. System 686 replaces such solvents, that may be potentially damaging to SEL stage 544 or which may reduce the performance of stage 544 or system 560, with a solvent or solvent that are more friendly to stage 544 and/or SEL sensing system 560. Solvent exchange system 686 comprises solvent input 688 and solvent exchanger 690.

Solvent input 688 comprise a source reservoir containing, or input ports for receiving, a solvent that is to carry the associated eluate fraction and that is selected for use with stage 544 and SEL sensing system 560. In one implementation, the solvent may comprise a liquid that, when deposited upon nano pillars of stage 544 and subsequently evaporated, facilitates closure of such nano pillars. For example, in one implementation, the solvent may comprise ethanol.

Solvent exchanger 690 withdraws or extracts the solvents which were part of the solution discharged by chromatography substrate 580 and replaces such solvents with the solvent provided by input 688. The replaced solvent may be discharged as waste. In one implementation, solvent exchanger 690 removes the solvent from the remainder of the eluate fraction by diffusion of co-flowing streams where the analytes diffuse from the original solvent to the new one.

System 620 operates in a fashion similar to that described above with respect to system 520. System 620 may carry out each of method 100 and 300 described above. System 620 may operate in a mode in which the current solvent or solvents being utilized in chromatography subsystem 524 and contained in the portion of the eluate fraction to be dispensed by dispenser 534 are replaced by system 686. In one implementation, controller 552 may receive input from an operator requesting the exchange of the solvent by solvent exchange system 686. In another implementation, controller 552 may automatically operate in the solvent exchange mode in response to identifying or sensing the solvents utilized in inputs 574 as not being friendly or being less than optimal for use with the particular stage 544 being used.

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A chromatography-surface enhanced luminescence (SEL) sensing system comprising:
a chromatography subsystem to separate sample into eluate fractions, the fractions having different elution times;
a SEL stage; and
an eluate fraction dispenser to direct different eluate fractions onto distinct regions of the SEL stage, wherein at least one of the dispenser and the stage are controlled to direct the different eluate fractions onto distinct regions of the SEL stage based upon the different elution times.

2. The system of claim 1 comprising:
an actuator to move the stage relative to the dispenser; and
a controller to output control signals causing the actuator to position the distinct regions of the SEL stage for receiving the different eluate fractions based upon the different elution times of the different eluate fractions.

3. The system of claim 2, wherein the SEL stage comprise a disk having distinct circumferential regions and wherein the actuator comprises a rotary actuator to rotate the distinct circumferential regions to receive the different eluate fractions based upon the different elution times of the different eluate fractions.

4. The system of claim 2, wherein the SEL stage comprises a strip having distinct linearly ordered regions, wherein the actuator comprises a linear actuator to translate the distinct linearly ordered regions to receive the different eluate fractions based upon the different elution times of the different eluate fractions.

5. The system of claim 2 further comprising a sample driver to supply the sample to the chromatography subsystem, wherein the controller outputs control signals controlling the supply of the sample by the sample driver to the chromatography subsystem.

6. The system of claim 2 further comprising an SEL sensor, wherein the actuator selectively positions the distinct regions of the SEL stage opposite the SEL sensor.

7. The system of claim 1 comprising:
an actuator to move the dispenser relative to the SEL stage; and
a controller to output control signals causing the actuator to position the dispenser to direct the different eluate fractions to the distinct regions of the SEL stage based upon the different elution times of the different eluate fractions.

8. The system of claim 1, wherein the eluate fraction dispenser comprises a nebulizer.

9. The system of claim 1 further comprising a solvent exchanger between the chromatography subsystem and the dispenser to exchange a solvent of the sample.

10. The system of claim 1 further comprising an SEL sensor opposite the SEL stage.

11. The system of claim 10 further comprising:
a parallel eluite sensing system; and
an eluite splitter between the chromatography subsystem and each of the SEL sensor and the parallel eluite sensing system to split and direct a first portion of one of the eluate fractions to the dispenser and a second portion of said one of the eluate fractions to the parallel eluite sensing system.

12. A method comprising:
separating a sample into eluate fractions using chromatography; and
directing the different eluate fractions onto distinct regions of a surface enhanced luminescence (SEL) stage based upon different elution times of the different eluate fractions.

13. The method of claim 13 further comprising:
sequentially positioning the distinct regions of the SEL stage with the respective different eluate fractions opposite to an SEL sensor; and
sensing each of the different eluate fractions with the SEL sensor.

14. A non-transitory computer-readable medium containing instructions for directing a processor to:
receive signals indicating movement of a sample through a chromatography subsystem;
determine different elution time for different eluate fractions from the chromatography subsystem; and
output control signals to an actuator to move one of a dispenser and a surface enhanced luminescence (SEL) stage relative to one another based upon the different elution times for different eluate fractions to direct the different eluate fractions to distinct regions of the SEL stage.

15. The non-transitory computer-readable medium of claim 14, wherein the instructions further direct the processor to output control signals to the actuator to move the distinct regions of the SEL stage opposite to an SEL sensor.
